(19) United States
(12) Patent Application Publication
(10) Pub. No.: US 2015/0306713 A1
(43) Pub. Date: Oct. 29, 2015

(54) A METHOD OF FABRICATING A ROTOR OF A TURBOFAN ENGINE

(71) Applicant: UNITED TECHNOLOGIES CORPORATION, Hartford, CT (US)

(72) Inventors: Steve A. McLeod, Rocky Hill, CT (US); Daryl A. Baker, Columbia, CT (US)

(21) Appl. No.: 14/646,801

(22) PCT Filed: Dec. 2, 2013
(86) PCT No.: PCT/US13/72553

§ 371 Date: May 22, 2015

Related U.S. Application Data
(60) Provisional application No. 61/732,709, filed on Dec. 3, 2012.

(51) Int. Cl. B23P 15/00; F01D 5/02

(52) U.S. Cl. CPC B23P 15/006; F01D 5/02; F05D 2220/30; F05D 2230/60; F05D 2230/00

(57) ABSTRACT

A method of fabricating a disk assembly for a turbofan engine is disclosed and includes the steps of forming a first and second disk and welding the second disk to the first disk to form a weld joint. A portion of the first disk and the second disk are removed along the weld joint on at least one surface to reduce a size of a heat affected zone and substantially reduce possible formation of material inconsistencies.

### CROSS REFERENCE TO RELATED APPLICATION

This application is a National Phase of PCT Application No. PCT/US2013/072553 filed on Dec. 2, 2013, which claims priority to United States Provisional Application No. 61/732,709 filed on Dec. 3, 2012.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high-pressure compressors, and the turbine section typically includes low and high-pressure turbines.

The high-pressure turbine typically drives the high-pressure compressor through an outer shaft to form a high spool, and the low-pressure turbine typically drives the low-pressure compressor through an inner shaft to form a low spool. The fan section may also be driven by the low inner shaft. A direct drive gas turbine engine includes a fan section driven by the low spool such that the low-pressure compressor, low-pressure turbine and fan section rotate at a common speed in a common direction.

The compressor section and the turbine section each include rotors that operate at significant speeds. Seals between rotors and static parts are utilized and are typically referred to as knife-edge seals. In some fabrication processes the knife-edge seals are attached to a disk to form a completed rotor. The attachment point or joint is required to withstand the harsh environment within which the compressor and turbine operate. Moreover, the processes and material utilized to fabricate such rotors must account for manufacturing and economic efficiency while still providing the desired operational performance.

### SUMMARY

A method of fabricating a disk assembly for a turbofan engine according to an exemplary embodiment of this disclosure, among other possible things includes, forming a first disk, forming a second disk, joining the second disk to the first disk to form a joint between the first disk and the second disk, and removing a portion of the first disk and the second disk along the joint on at least one surface to reduce a size of a heat affected zone (HAZ).

In a further embodiment of the foregoing, at least one surface comprises a radially outer surface of the first disk and the second disk along the joint.

In a further embodiment of any of the foregoing, includes the step of heat-treating the first disk and the second disk after formation of the joint and before removal of a portion along the joint.

In a further embodiment of any of the foregoing, a joint extends radially outward from an interior radial surface to an outer radial surface.

In a further embodiment of any of the foregoing, includes removing a portion of the first disk and the second disk comprises removing reducing a radial thickness between the interior radial surface and the outer radial surface.

In a further embodiment of any of the foregoing, includes removing material from the radial outer surface to reduce the radial thickness.

In a further embodiment of any of the foregoing, includes removing more than 25% of the radial thickness.

In a further embodiment of any of the foregoing, includes removing material from the interior radial surface to reduce the radial thickness.

In a further embodiment of any of the foregoing, includes the step of finish machining the disk assembly after removal of the portion along the joint.

In a further embodiment of any of the foregoing, includes the step of determining a heat affected zone along the joint and removing more than 50% of material within the determined heat affected zone from an outer radial surface.

In a further embodiment of any of the foregoing, the disk assembly forms a portion of a compressor section of the turbofan engine.

In a further embodiment of any of the foregoing, a portion of the first disk and the second disk comprises a knife-edge spacer.

In a further embodiment of any of the foregoing, formation of the joint includes an electron beam welded to form the weld joint.

A method of assembling a compressor section of a turbofan engine according to an exemplary embodiment of this disclosure, among other possible things includes forming a first disk including features for supporting a blade, forming a second disk including a seal edge, joining the first disk and the second disk at a joint, heat treating joined first and second disks, determining a heat affected zone along the joint, and removing a portion of the first disk and the second disk along the joint on at least one surface to reduce a size of the determined heat affected zone.

In a further embodiment of the foregoing, includes removing material along an outer radial surface to reduce a radial length of the joint.

In a further embodiment of any of the foregoing, includes removing material along an inner radial surface to reduce a radial length of the joint.

In a further embodiment of any of the foregoing, includes removing material axially forward and axially aft of the joint to reduce the size of the determined heat affected zone.

In a further embodiment of any of the foregoing, includes installing at least one blade to the joined first and second disks after removing a portion of the determined heat affected zone and to form a completed compressor disk and installing the completed compressor disk into the compressor section of the turbofan engine.

In a further embodiment of any of the foregoing, including joining the first disk and the second disk at a joint with electron beam welding to form a weld joint.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2 is a schematic view of a portion of an example compressor disk assembly.

FIG. 3 is another schematic view of an example compressor disk assembly.

FIG. 4 is another schematic view of the example compressor disk assembly.

FIG. 5 is a schematic view of an example process of assembling a compressor section of a turbofan engine.

### DETAILED DESCRIPTION

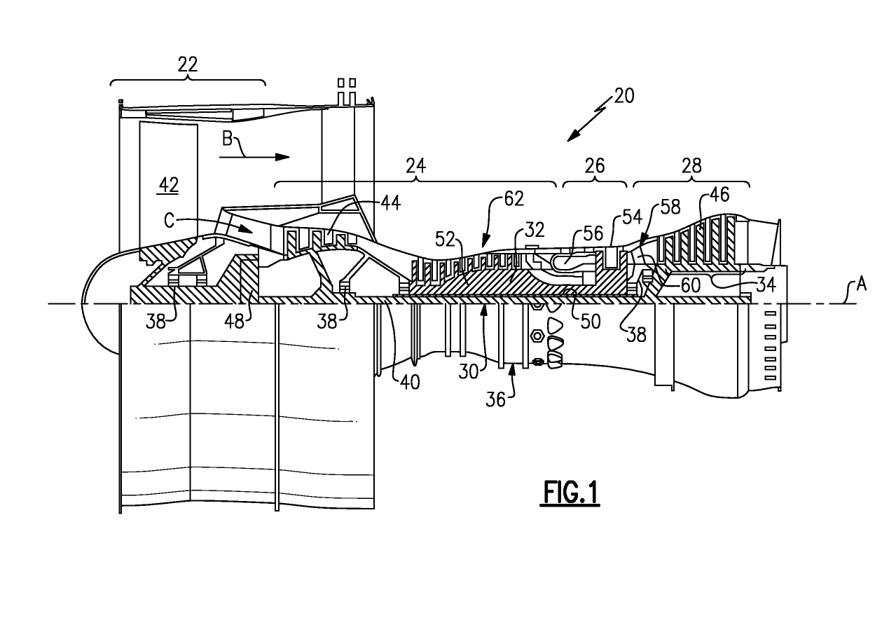

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high-pressure exhaust gas stream that expands through the turbine section 28 where energy is extracted and utilized to drive the fan section 22 and the compressor section 24.

Although the disclosed non-limiting embodiment depicts a two-spool turbofan gas turbine engine, it should be understood that the concepts described herein are not limited to use with two-spool turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high-pressure compressor 52 and the high-pressure turbine 54. In one example, the high-pressure turbine 54 includes at least two stages to provide a double stage high-pressure turbine 54. In another example, the high-pressure turbine 54 includes only a single stage. As used herein, a “high pressure” compressor or turbine experiences a higher pressure than a corresponding “low pressure” compressor or turbine.

The example low-pressure turbine 46 has a pressure ratio that is greater than about 5. The pressure ratio of the example low-pressure turbine 46 is measured prior to an inlet of the low-pressure turbine 46 as related to the pressure measured at the outlet of the low-pressure turbine 46 prior to an exhaust nozzle.

A mid-turbine frame 58 of the engine static structure 36 is arranged generally between the high-pressure turbine 54 and the low-pressure turbine 46. The mid-turbine frame 58 further supports bearing systems 38 in the turbine section 28 as well as setting airflow entering the low pressure turbine 46.

Airflow through the core flow path C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 58 includes vanes 60, which are in the core airflow path and function as an inlet guide vane for the low-pressure turbine 46. Utilizing the vane 60 of the mid-turbine frame 58 as the inlet guide vane for low-pressure turbine 46 decreases the length of the low-pressure turbine 46 without increasing the axial length of the mid-turbine frame 58. Reducing or eliminating the number of vanes in the low-pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low-pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption ('TSFC')”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram ° R)/ (518.7° R)]^{0.5}. The “Low corrected fan tip speed”, as disclosed herein according to one non-limiting embodiment, is less than about 1150 ft/second.

The example gas turbine engine includes the fan 42 that comprises in one non-limiting embodiment less than about 26 fan blades. In another non-limiting embodiment, the fan section 22 includes less than about 20 fan blades. Moreover, in one disclosed embodiment the low-pressure turbine 46 includes no more than about 6 turbine rotors schematically indicated at 34. In another non-limiting example embodiment the low-pressure turbine 46 includes about 3 turbine rotors. A ratio between the number of fan blades 42 and the number of low-pressure turbine rotors is between about 3.3 and about 8.6. The example low-pressure turbine 46 provides the driving power to rotate the fan section 22 and therefore the relationship between the number of turbine rotors 34 in the low-pressure turbine 46 and the number of blades 42 in the fan section 22 discloses an example gas turbine engine 20 with increased power transfer efficiency.

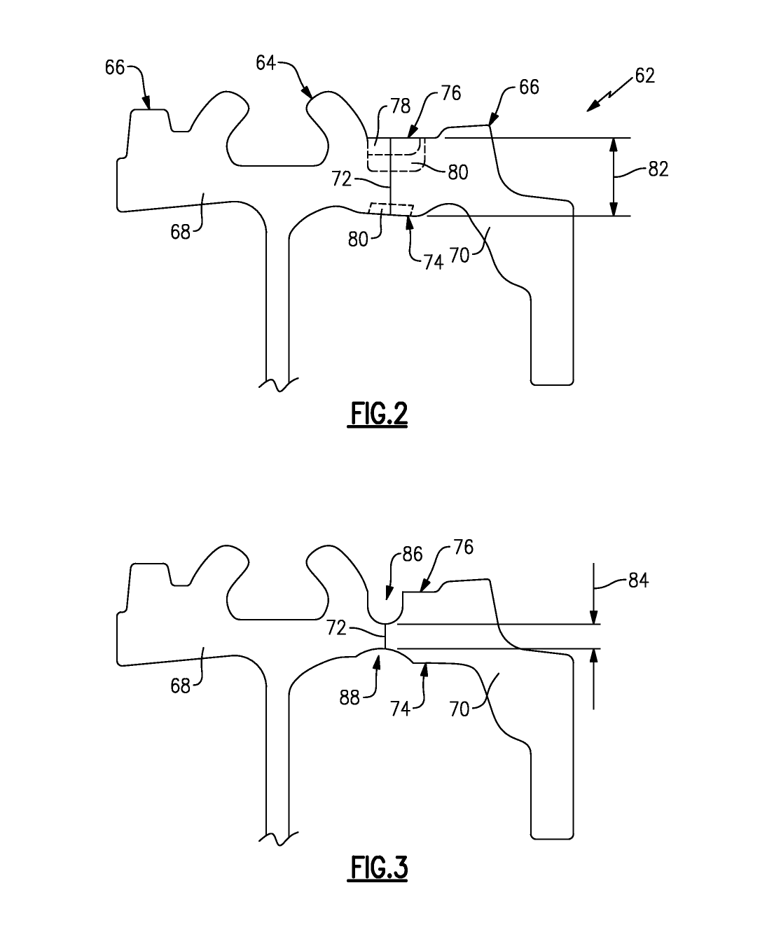

Referring to FIG. 2, with continued reference to FIG. 1, a portion of a compressor disk assembly 62 is schematically shown and includes a feature 64 for supporting a blade 102 (FIG. 5) and a plurality of features for forming knife-edge seals 66. The example compressor disk assembly 62 is formed from a first disk 68 that is jointed to a second disk 70. The first disk 68 is joined to the second disk 70 along a welded joint 72. The example joint 72 extends radially between an interior radial surface 74 and an outer radial surface 76. As hereafter explained, in conventional designs, the joint 72 between the first disk 68 and the second disk 70 may have problems associated with cracks along the weld joint 72.

In this example, the compressor disk assembly 62 comprises a portion of the high-pressure compressor 52. The disk assembly 62 is formed by attaching the first disk 68 to the second disk 70 utilizing an electron beam (EB) welding process to form the joint 72. The joined first and second disks 68, 70 are then heat treated to relieve residual stresses. After welding, a heat affected zone is formed at the edges of the weld joint 72. The heat affected zone areas at outer radial area location 78 and the interior radial located area zone 80 are susceptible to the formation of microcracks. Cracks or other inconsistences surrounding the joint 72 are not desirable.

Prior art methods of eliminating the formation of cracks within the heat affected zones 78 and interior radial area 80 include the use of expensive material and special heat treating operations that complicate manufacture and increase cost. A disclosed method provides for the use of lower cost material and conventional processes while substantially eliminating potential cracks within the heat affected zone.

The weld joint 72 is approximately 0.5 in. thick prior to final machining An amount of sacrificial material 80 is provided on the outer radial surface 76 and interior radial surface 74. It should be understood, that the radial thickness of the weld joint 72 may be changed to join different disk stages and sections. Moreover, the radial thickness may be determined based on the size of the heat-affected zone formed after welding. Upon completion of the weld joint 72, a heat treatment operation is performed to relieve any residual stress within the part.

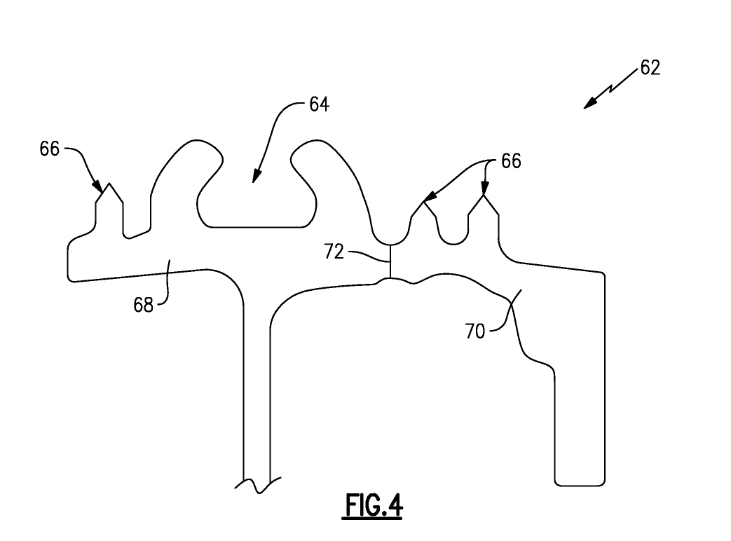

Referring to FIG. 3 with continued reference to FIG. 2, after heat treat, the joint 72 is machined to remove the heat-affected zone 78. In this example, the initial radial thickness of the weld joint 72 is reduced from approximately 0.50 inches, indicated at 82 in FIG. 2, to a thickness of approximately 0.250 inches as is indicated at 84 in FIG. 3.

The reduced thickness 84 is provided by removing material predominantly from the radially outer surface 76. Material is removed on either axial side of the weld joint 72 along with radially along the weld joint 72. Removing more material from an outer side of the weld removes any expected HAZ microcracks that may be produced during welding because generally, HAZ microcracks form in the outer most ⅓ area of the weld joint 72. Some material is removed from the inner radial surface 74 as is indicated at 88 to provide a substantially microcrack free weld joint 72 while also providing for sufficient material to form a desired final shape.

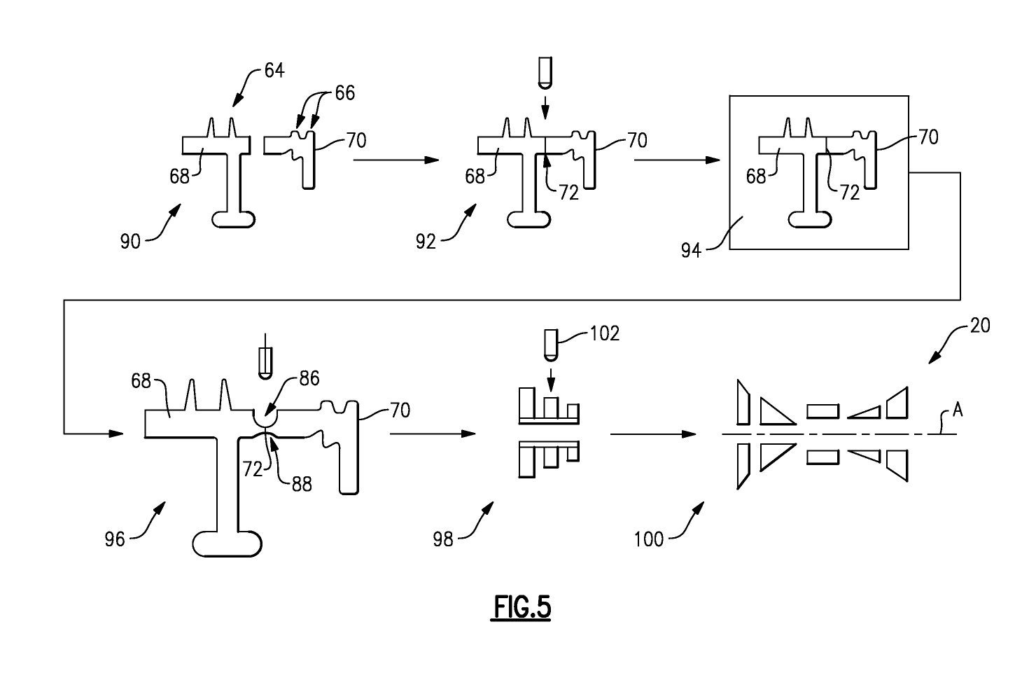

Referring to FIG. 4, with continued reference to FIGS. 2 and 3, the disk assembly 62 is finish machined to form the knife-edge seals 66 and complete the blade supporting feature 64. The knife-edge seals 66 and blade support features 64 are machined and finished using known disk machining and finishing processes.

Referring to FIG. 5 with continued reference to FIGS. 2, 3 and 4, an example method of assembling a compressor section of a turbofan engine includes the initial step schematically indicated at 90 of forming the first disk 68 including features 64 for supporting a blade 102 and forming the second disk 70 including features for forming seal edge 66. A welding process indicated at 92 is utilized to form the joint 72 between the first disk and the second disks 68, 70. The example joint 72 extends radially outward relative to the engine axis A from the interior radial surface 74 to the outer radial surface 76

The joined first and second disks 68, 70 are then heat treated as is indicated at 94 to relieve residual stresses caused by the joint welding process. The welding process generates a heat affected zone along the weld joint 72, which can generate microcracks in locations 78 and interior radial zone 80 (FIG. 2). A determination of the extent of material and dimensions around the weld joint 72 is made to define the approximate dimensions of the heat-affected zone 78 and interior radial zone 80 that are required to eliminate microcracking.

Once the dimensions and size of the heat-affected zones 78 and interior radial area zone 80 are understood, a machining step is performed as is indicated at 96. The machining step 96 removes material from portions of the first disk 68 and the second disk 70 along the weld joint 72 on at least one surface to reduce a size of the determined heat affected zone. Material is removed from the outer radial surface as is indicated at 86 to reduce the radial thickness 84 (FIG. 3) of the weld joint 72. Material 88 may also be removed from the inner radial surface 74 to further reduce a radial thickness of the weld joint 72. Moreover, material is removed axially forward and axially aft of the weld joint 72 to reduce the size of the determined heat affected zone 78 and interior radial zone 80.

Once the machining step is completed to remove the heat affected zone 78 from around the weld joint 72, finish machining steps are performed to provide a desired final shape and complete the blade supporting features 64 (FIG. 4) and the edge seals 66. The completed compressor disk assembly 62 is then assembled into a compressor section as is schematically shown at 98. In the disclosed example, a portion of the high-pressure compressor 52 is formed.

Assembly of the compressor section incudes installing at least one blade 102 to the compressor disk assembly 62 to form a completed compressor disk and installing the completed compressor disk into the compressor section of the turbofan engine. The completed compressor section is then assembled into the turbofan engine 20 as is schematically shown at 100.

It should be understood, that although the example process is described with reference to formation of a compressor disk and compressor section, it is within the contemplation of this disclosure that other disk assemblies such as are utilized in the turbine section or other compressor sections would also benefit from the disclosed methods.

Accordingly, the example method provides an alternative to conventional solutions attempted to limit microcracks.

The example disclosed method provides for use of more cost effective materials while also eliminating the need to recertify and conduct costly qualification testing. The example method provides for a reduction in manufacturing costs instead of implementing a costly alternative design. The disclosed method further enables a more timely development solution and facilitated a minimum design risk option.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A method of fabricating a disk assembly for a turbofan engine comprising:
forming a first disk;
forming a second disk;
joining the second disk to the first disk to form a joint between the first disk and the second disk; and
removing a portion of the first disk and the second disk along the joint on at least one surface to reduce a size of a heat affected zone.

2. The method as recited in claim 1, wherein the at least one surface comprises a radially outer surface of the first disk and the second disk along the joint.

3. The method as recited in claim 1, including the step of heat-treating the first disk and the second disk after formation of the joint and before removal of a portion along the joint.

4. The method as recited in claim 1, wherein joint extends radially outward from an interior radial surface to an outer radial surface.

5. The method as recited in claim 4, wherein removing a portion of the first disk and the second disk comprises removing reducing a radial thickness between the interior radial surface and the outer radial surface.

6. The method as recited in claim 5, including removing material from the radial outer surface to reduce the radial thickness.

7. The method as recited in claim 5, including removing more than 25% of the radial thickness.

8. The method as recited in claim 5, including removing material from the interior radial surface to reduce the radial thickness.

9. The method as recited in claim 1, including the step of finish machining the disk assembly after removal of the portion along the joint.

10. The method as recited in claim 1, including the step of determining a heat affected zone along the joint and removing more than 50% of material within the determined heat affected zone from an outer radial surface.

11. The method as recited in claim 1, wherein the disk assembly forms a portion of a compressor section of the turbofan engine.

12. The method as recited in claim 1, wherein a portion of the first disk and the second disk comprises a knife-edge spacer.

13. The method as recited in claim 1, wherein formation of the joint comprises electron beam welding to form a weld joint.

14. A method of assembling a compressor section of a turbofan engine comprising:
forming a first disk including features for supporting a blade;
forming a second disk including a seal edge;
joining the first disk and the second disk at a joint;
heat treating joined first and second disks;
determining a heat affected zone along the joint; and
removing a portion of the first disk and the second disk along the joint on at least one surface to reduce a size of the determined heat affected zone.

15. The method as recited in claim 14, including removing material along an outer radial surface to reduce a radial length of the joint.

16. The method as recited in claim 14, including removing material along an inner radial surface to reduce a radial length of the joint.

17. The method as recited in claim 14, including removing material axially forward and axially aft of the joint to reduce the size of the determined heat affected zone.

18. The method as recited in claim 14, including installing at least one blade to the joined first and second disks after removing a portion of the determined heat affected zone and to form a completed compressor disk and installing the completed compressor disk into the compressor section of the turbofan engine.

19. The method as recited in claim 14, joining the first disk and the second disk at a joint comprises electron beam welding to form a weld joint.
